(19) United States
(12) Patent Application Publication
(10) Pub. No.: US 2008/0206385 A1
(43) Pub. Date: Aug. 28, 2008

(54) High Force Indentation Apparatus With High Accuracy

(75) Inventors: Krassimir Todorov Krastev, Eindhoven (NL); Raymond Jacobus Wilhelmus Knaapen, Eindhoven (NL); Marinus Josephus Jakobus Dona, Veldhoven (NL); Patericus Dijk, Roosendaal (NL); Johannes Martinus Maria Swinkels, Eindhoven (NL); Johannes Cornelis Van Den Ven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,328

(22) PCT Filed: Apr. 28, 2006
(86) PCT No.: PCT/IB2006/051339

§ 371 Date: Nov. 1, 2007

(30) Foreign Application Priority Data
May 4, 2005 (EP) 05103731.5

(51) Int. Cl. B29C 33/38

(52) U.S. Cl. 425/167; 264/219; 425/177; 425/149

(57) ABSTRACT

The invention relates to an indentation apparatus (1) comprising a force frame (13) and a positioning frame (14). An indentation tool (5) is pressed into a work piece (7) in order to master a mould. The work piece (7) is supported by the base (6). An actuator (2) is mounted in the force frame (13). The actuator (2) and the indentation tool head (4) are connected with a rod (3). The rod (3) is fixed with flexible (swivel) joints (15) to said indentation tool (4) and said actuator (2) in order to physically decouple said force frame (13) and said positioning frame (14) from forces. Also a force sensor (9) is installed between the indentation tool (4) and the positioning frame (14). In order to keep the positioning frame unloaded, the balance force delivered by said force frame actuator (2) should be approximately equal to the indentation force. The signal of the force sensor (9) is interpreted by control electronics (10). The control electronics determine the force of actuator (2) such that the force measured at the force sensor (9) is approximately at zero level. In order to align actuator (2), rod (3) and indentation tool (4) axially, the actuator (2) will be moved as follower of the indentation tool head (5) movement.

The invention relates to an apparatus for actuating a tool with high pressure and high accuracy and a method of reduction or elimination of tool position deviation of such an apparatus.

High forces for actuating a tool are required for various industrial applications. For example, indentation tools are used for plastic deformation in order to manufacture molds. Especially optical lenses and lens arrays can be mastered in large scale manufacture by indentation. There are high demands for accuracy for such applications. For small optical lenses, e.g. for digital cameras for mobile phones, the accuracy has to be better than 10 μm. There are required very large forces for the indentation, in some cases more than 1500 N. Such enormous forces cause deformations in the whole indentation apparatus. These deformations are difficult to compensate. Non-uniform twisting and distortion limit the accuracy of the indentation positioning.

JP 2002-248628 (Susumo et al.) for example shows such an apparatus for forming microlens arrays.

It is therefore an object of the invention to improve the accuracy of a high force indentation apparatus.

It is another object of the invention to provide an effective method of controlling an indentation apparatus with high accuracy. Deformation of the indentation apparatus shall be reduced.

According to the invention, there is provided an apparatus for actuating at least one tool in at least one direction with high accuracy. The apparatus comprises a base for supporting at least one work piece, a force frame being coupled with the tool to deliver balance force in at least one direction, and positioning means having a measuring system for accurate positioning of the tool, the positioning means being at least partially physically decoupled from said force frame in order to avoid influences from a deviation caused by forces in said force frame.

The force frame can move the tool with high accuracy in at least one direction; thereby the force frame delivers force in order to press the tool in an axial direction, e.g. as an indentation tool.

The positioning means are at least partially physically decoupled from said force frame and said base in order to avoid influences from a deviation caused by the force delivered by the force actuator.

According to the invention, a deviation of the tool position during indentation can be reduced or eliminated by balancing the indentation force with an applied counterforce. In order to achieve this compensation, an actuator, mounted in the force frame is coupled with the tool holding fixture. The actuator frame and the tool holding fixture with the positioning frame can move together with respect to the base in horizontal direction.

It is an alternative to move the base with the work piece in horizontal direction.

Preferably, the positioning means are physically decoupled in horizontal direction from the actuator. This is achieved by a rod, which joins the force frame actuator and the tool holding fixture, which is coupled with flexible or swivel joints at both ends.

Accordingly, force frame and base are radially decoupled.

According to a further preferred embodiment of the invention, the positioning means comprise a positioning frame for accurate positioning of said tool and positioning of said force actuator. The positioning frame can be at least temporarily physically decoupled from said base and said force frame and is coupled with said tool holding fixture with flexible joints and a force sensor. The flexible joints and the force sensor are arranged accordingly so that the vertical force between the tool holding fixture and the positioning frame could be measured.

Preferably, the base or the tool holding fixture and the actuator can be moved as well in x- as in y-direction.

In order to compensate an axial deviation, the tool is moved with a force actuator as follower of the positioning frame movement.

The invention also relates to a system for actuating at least one tool in an apparatus with a base and a force frame with high positioning accuracy. The system comprises means in order to eliminate a deviation of the tool position. In order to eliminate a deviation of the accurate position of the tool, the alignment is controlled by force measuring means. The force measuring means signal a deviation of the tool position. A high accuracy is achieved by physically decoupling the tool positioning means from the force frame.

In a preferred embodiment, an appearance of axial force can be measured between said tool and positioning frame, which can be at least temporarily decoupled from the base and the force frame. This force can be balanced with controlled force of the said actuator of the force frame in order to avoid deviation of the said tool position.

The system might also be mounted in an existing conventional indentation apparatus. According to the invention, said force frame actuator and indentation tool head, which is part of the indentation tool, will always be guided collinear.

The invention also relates to a method for controlling an indentation apparatus comprising an indentation tool head, a force frame and a base, featuring high positioning accuracy of the tool head with respect to the base.

When a work piece is pressed with an indentation tool in order to form a mold, the axial alignment of the indentation tool head and the force actuator are insured. The tool and the tool holding fixture are actuated substantially in the indentation direction in order to eliminate a radial deviation of the indentation tool head position.

Preferably, a rod flexibly is mounted in between physically decouples positioning frame and force frame.

It is to be noted that the present invention relates in particular to an indentation apparatus. But the concept of the invention might be also used for other industrial applications wherein a tool is actuated in an axial direction with high forces, for example bonding, milling apparatuses, deep-drawing tools etc.

In the following preferred embodiments of the invention will be described in greater detail, by way of example only, making reference to the drawings in which

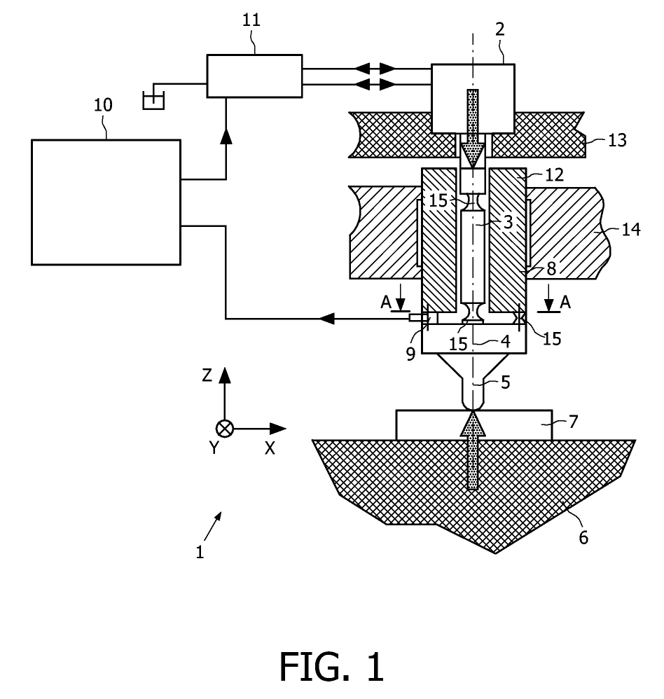

FIG. 1 shows a schematic view of an indentation apparatus according to the invention,

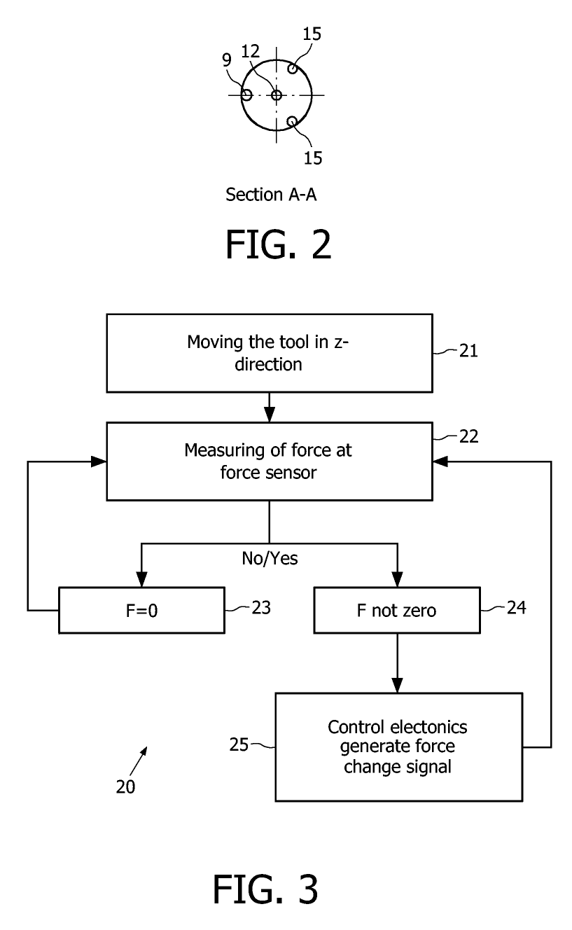

FIG. 2 shows a schematic cross section along line A-A of FIG. 1,

FIG. 3 shows a schematic flow diagram of a method of controlling an indentation apparatus with high accuracy,

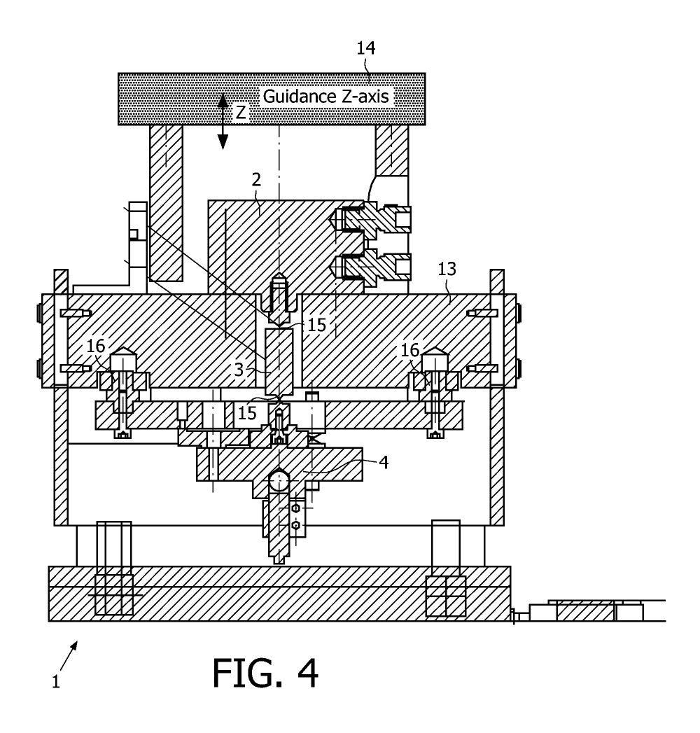

FIG. 4 shows a schematic cross section of an alternative embodiment of an indentation apparatus.

FIG. 1 shows a schematic view of an indentation apparatus 1 according to a preferred embodiment of the invention. The indentation apparatus 1 comprises a force frame 13 and a positioning frame 14. An indentation tool 4 can be actuated with high force in z-direction (marked with an arrow). The indentation tool head 4 comprises an indentation tool 5, which is pressed into a work piece 7 in order to master a mold. The work piece 7 is supported by the base 6. An actuator 2 is mounted in the force frame 13. The actuator 2 and the indentation tool head 4 are connected with a rod 3. The rod 3 is fixed with flexible (swivel) joints 15 to said indentation tool 4 and said actuator 2 in order to physically decouple said force frame 13 and said positioning frame 14 from forces at least in x, y-direction.

For accurate positioning of the indentation tool, the positioning frame 14 of the indentation apparatus comprises a guidance 8. The positioning frame 14 can be at least temporarily physically decoupled from the base 6 and the force frame 13. The said indentation tool 4 is coupled by flexible joints 15 to the said guidance 8 of the positioning frame 14.

Accordingly, the positioning frame 14 remains unloaded during indentation. Also a force sensor 9 is installed between the indentation tool 4 and the guidance 8.

In order to keep the positioning frame unloaded, the balance force delivered by said force frame actuator 2 should be approximately equal to the indentation force. Accordingly, the force measured by the force sensor 9 is at approximately zero level.

The signal of the force sensor 9 is interpreted by control electronics 10. The actuator control 11 is controlled by control electronics 10. The control electronics determine the force of actuator 2 such that the force measured at the force sensor 9 is approximately at zero level.

Actuator 2, rod 3 and indentation tool 4 are always collinear. In order to align actuator 2, rod 3 and indentation tool 4 axially, the actuator 2 will be moved in x, y-direction as follower of the indentation tool head 5 movement.

The force in z-direction causes radial misalignments, which are eliminated with applied balance forces. Due to the fact that there are high forces in z-direction only, compensating of torsional deviation is not necessary in this embodiment.

With this embodiment, it is possible to provide a high force indentation apparatus 1 with an accuracy of 1 μm or better.

FIG. 2 shows a schematic cross section along line A-A of FIG. 1. One force sensor 9 and two flexible joints 15 are placed circular around the z-axis 12 of the rod of FIG. 1 at an angle of 120° to each other. A difference between the indentation force and balance force will cause a reaction force in the force sensor 9, which can be measured. Thus the control electronics can compensate for a difference between the indentation force and the balance force.

FIG. 3 shows a flow diagram 20 of the actuator control. The tool is moved in z-direction (step 21) in order to form a mold. The vertical force at the force sensor is measured (step 22). If the force is zero the value of the balance force is correct (step 23), and the control returns to step 22. If a deviation of the force from zero level is measured (step 24), the control electronics change the value of the signal to the actuator control (step 25), which results in a balance force change. Then, the control loop returns to step 22. As a result of this control method actuator, rod and indentation tool are always kept collinear.

FIG. 4 shows a schematic cross section of an alternative embodiment of an indentation apparatus 1. In contrast to the embodiment of FIG. 1, the positioning frame 14 with the guidance (not depicted) stays above the force frame 13. Accordingly, the rod 3 with flexible joints 15 does not extend trough the guidance.

The force frame 13 is repositioned in x-y-direction so that said indentation tool 5, rod 3 and actuator 2 stay always collinear. During indentation, locating pins 16 decouple the force frame 13 from the positioning frame 14. The force frame 13 slides on air bearings. The air bearings are turned into vacuum chucks during indentation and keep the force frame bridge fixed.

It will be appreciated by persons skilled in the art that the present invention is not limited to what has been particularly shown and described above. The scope of the present invention includes both combinations and sub combinations of the various features described above as well as modifications and variations thereof, as would occur to a person of skill in the art upon reading the foregoing specification and which are not in the prior art.

### LIST OF REFERENCES NUMERALS

1 indentation apparatus
2 actuator
3 rod
4 indentation tool head
5 indentation tool
6 base
7 work piece
8 guidance
9 force sensor
10 control electronics
11 actuator control
12 z-axis
13 force frame
14 positioning frame
15 flexible joint
16 locating pins
20 flow diagram
21 moving tool in z-direction
22 measuring of force at force sensor
23 correct force level F=0 (approximately)
24 force deviation from F=0
25 control electronics generate force change signal

1. Apparatus for actuating at least one tool in at least one direction with high accuracy, comprising
a base (6) for supporting at least one work piece (7),
a force frame (13) being coupled with said tool (4) to deliver balance force in at least one direction,
positioning means having a measuring system for accurate positioning of the tool (4), characterized in that the positioning means being at least partially physically decoupled from said force frame (13) in order to avoid influences from a deviation caused by forces in said force frame.

2. Apparatus according to claim 1, characterized in that the positioning means being physically decoupled with at least one flexible or swivel joint.

3. Apparatus according to claim 1, characterized by a rod which joins said force frame and said tool.

4. Apparatus according to claim 3, characterized in that said rod is coupled with flexible or swivel joints to said force frame and said tool.

5. Apparatus according to claim 1 characterized in that said positioning means comprise a positioning frame (14) with measuring system for accurate positioning of said tool and positioning means of said force actuator.

6. Apparatus according to claim 5, characterized in that said positioning frame (14) can be physically decoupled from said force frame (13) and/or said base (6).

7. Apparatus according to claim 5, characterized in that said positioning frame is coupled with flexible or swivel joints to said tool.

8. Apparatus according to claim 5, characterized by at least one force sensor being arranged between said tool head and said positioning frame in order to measure an axial force between tool and positioning frame.

9. Apparatus according to claim 1, characterized in that said force frame, said tool and/or said base can be moved in at least one direction.

10. Apparatus according to claim 1, characterized in that said apparatus is an indentation apparatus.

11. System for controlling an apparatus for actuating at least one tool with high positioning accuracy, the apparatus comprising a base (6) and a force frame (13), said system comprising,
means to eliminate a deviation of the tool (4),
means for vertical and/or horizontal movement of said base (6) and/or said tool (4),
control electronics to control the movement of said base (6), said tool and/or said actuator (2) characterized in that said means to eliminate a deviation of the tool (4) are physically decoupled from said positioning frame (14).

12. A system for controlling an indentation apparatus according to claim 1, characterized in that said means to eliminate a deviation of the tool (4) comprise a positioning frame (14) and force frame (13).

13. A system for controlling an indentation apparatus according to claim 1, characterized in that at least one force sensor is arranged between positioning frame (13) and said tool (4), said sensor being connected with said control electronics.

14. Method for controlling an indentation apparatus (I) comprising an indentation tool head (5), an actuator (2) and a base (6) with high positioning accuracy, said method comprising:
pressing a work piece (7) with an indentation tool (4) in order to form a mold,
ensuring the axial alignment of the indentation tool head (5) and the actuator (2),
actuating the actuator (2) substantially in the indentation direction in order to eliminate an axial deviation of the indentation tool head (5) position.

15. Method for controlling an indentation apparatus according to claim 1, characterized in that the axial alignment is achieved with a positioning frame (14), said positioning frame (14) being physically decoupled from said force frame of said indentation apparatus (1).

16. Method for controlling an indentation apparatus according to claim 1, characterized in that the axial force is measured by at least one force sensor, which is arranged between said indentation tool and said positioning frame.
